(19) United States
(12) Patent Application Publication
(10) Pub. No.: US 2008/0198527 A1
(43) Pub. Date: Aug. 21, 2008

(54) Surge protection device and surge protection apparatus using thereof

(75) Inventors: Shuji Higashi, Tokyo (JP); Yoshio Igarashi, Tokyo (JP); Yukio Uwano, Tokyo (JP); Yasuharu Yamada, Tokyo (JP)

Correspondence Address: MERCHANT & GOULD PC, P.O. BOX 2903, MINNEAPOLIS, MN, 55402-0903, US

(73) Assignee: SANKOSHA CORPORATION, Tokyo (JP)

(21) Appl. No.: 11/807,806

(22) Filed: May 30, 2007

(30) Foreign Application Priority Data
Feb. 19, 2007 (JP) 2007-038173

(51) Int. Cl. H02H 3/22; H01C 7/12

(52) U.S. Cl. 361/118

(57) ABSTRACT

In a surge protection device 40 (40-1 or 40-2) used for a surge protection apparatus, a gas arrester 41 is connected in series with a varister group consisting of a plurality of varisters 42-1 to 42-5 which have high withstand capacity and are connected in parallel to one another and a discharge resistor 43 is connected between both electrodes of the varister group. Besides, since the varister voltages are set higher than the peak value of the AC power supply voltage, the varisters 42-1 to 42-5 are normally insulated from a power supply circuit by the gas arrester 41. Even if an abnormal voltage is applied, since an operating voltage of the varisters 42-1 to 42-5 is set higher than a peak value of the AC power supply voltage, AC power supply current will not flow. Charges stored in the varisters 42-1 to 42-5 are released quickly through the resistor 43, making it possible to prevent the gas arrester 41 from restriking. This provides a small, reliable, inexpensive surge protection device (SPD) relatively simple in structure and a surge protection apparatus using thereof.

### BACKGROUND ART

1. Field of the Invention

The present invention relates to a surge protection device (hereinafter referred to as an “SPD”) which is a protector used to protect electrical apparatus, communications electrical apparatus, and other target apparatus from abnormal voltages caused by lightning surges such as indirect strokes or direct strokes as well as to a surge protection apparatus using thereof. More particularly, it relates to an SPD for power supplies which require high current withstand capacity as well as to a surge protection apparatus using thereof.

2. Description of the Related

Conventional SPDs for alternating current (hereinafter referred to as “AC”) power supplies include, for example a combination of gas discharge tubes (hereinafter referred to as “gas arresters”) and varisters. It is intended for protection from indirect strokes and compliant with a JIS (Japanese Industrial Standards) Class II protection level. If gas arresters are used alone for a power supply circuit, after the arresters are discharged by a lightning surge, the gas arresters may have their life shortened or may be even burnt out due to the phenomenon of follow current in which discharging is sustained by an AC power supply after extinction of the surge. To interrupt such follow current, the gas arresters and varisters are combined in series. If varisters are used alone for a power supply circuit, their characteristics may deteriorate with increases in the number of operations due to lightning surges, resulting in increases in leakage current, and finally in burnout. Thus, to interrupt follow current, gas arresters and varisters are used, being connected in series.

SPD techniques which use gas arresters and varisters in series are described, for example, in the following patent documents.

[Patent Document 1] Japanese Patent Laid-Open No. 2006-136043 (Surge Absorber)

[Patent Document 2] Japanese Patent Laid-Open No. 2006-60917 (Noise Filter Circuit for Switching Power Supply)

[Patent Document 3] Japanese Patent Laid-Open No. 2004-236413 (Noise Filter Circuit for Switching Power Supply)

[Patent Document 4] Japanese Patent Laid-Open No. 2001-268888 (Surge Protection Circuit and Power Supply Unit)

[Patent Document 5] Japanese Patent Laid-Open No. 9-172733 (Surge Voltage Absorption Circuit)

[Patent Document 6] Japanese Patent Laid-Open No. 9-103066 (Switching Regulator)

[Patent Document 7] Japanese Patent Laid-Open No. 7-39136 (Power Supply Unit for Electronic Equipment)

[Patent Document 8] Japanese Patent Laid-Open No. 5-199737 (AC Input Power Supply)

FIG. 1 is a schematic block diagram showing a conventional surge protection apparatus used to protect a target apparatus connected to a power distribution system (e.g., low-voltage distribution lines in a building or the like) from lightning surges.

For example, if a 6.6-kilovolt high voltage AC of a three-phase (3φ), three-wire system (3W) is inputted in a high voltage isolation transformer 1, it is supplied to two low-voltage distribution lines L1 and L2 and one neutral line N after being transformed into a low voltage (200 volts AC) of a single phase (1φ), three-wire (3W) commercial power system by the isolation transformer 1. The 200-volt low voltage AC supplied to the two low-voltage distribution lines L1 and L2 and one neutral line N is supplied to a target apparatus 3 such as electrical apparatus via an earth leakage breaker 2 to drive the target apparatus 3. The low-voltage neutral line N is grounded. Since lightning surges can occur not only with respect to the ground, but also between lines, in order to protect the target apparatus 3 from lightning surges, it is necessary to provide both apparatus-to-ground protection and line-to-line protection.

Thus, one L1 of the low-voltage distribution lines is connected to the neutral line N, for example, via a fuse 4-1 manufactured in compliance with a JIS Class I protection level and intended for protection from direct strokes and an SPD 10-1 manufactured in compliance with a JIS Class II protection level and intended for protection from indirect strokes. Similarly, the other low-voltage distribution line L2 is connected to the neutral line N via a fuse 4-2 manufactured in compliance with a JIS Class I protection level and intended for protection from direct strokes and an SPD 10-2 manufactured in compliance with a JIS Class II protection level and intended for protection from indirect strokes. Furthermore, the neutral line N is grounded via a ground side SPD 20. The SPDs 10 (i.e., SPD 10-1 and 10-2) are each composed of gas arresters and varisters such as described, for example, in Patent Document 1. The ground side SPD 20 consists, for example, of arresters.

FIG. 2 is a schematic circuit diagram showing a configuration of the conventional SPD 10 (SPD 10-1 or 10-2) in FIG. 1.

The SPD 10 has an input terminal 11 and output terminal 12 as described, for example, in Patent Document 1. A plurality of gas arresters 13-1 to 13-6 are connected in series between the input terminal 11 and output terminal 12. That is, the input terminal 11, a node 15-1, a gas arrester 13-1, a node 15-2, a gas arrester 13-2, a node 15-3, a gas arrester 13-3, a node 15-4, a gas arrester 13-4, a node 15-5, a gas arrester 13-5, a node 15-6, a gas arrester 13-6, a node 15-7, and the output terminal 12 are connected in series. A varister 14-1 is connected between the node 15-1 and node 15-6, and a varister 14-2 is connected between the node 15-2 and node 15-7. Furthermore, a varister 14-3 is connected between the node 15-2 and node 15-5, a varister 14-4 is connected between the node 15-3 and node 15-6, and a varister 14-5 is connected between the node 15-3 and node 15-4.

Next, operation of the SPD 10 shown in FIG. 2 will be described.

If a lightning surge voltage is applied between the input terminal 11 and output terminal 12 (i.e., between the node 15-1 and node 15-7), a lightning surge voltage is generated in a series circuit consisting of the gas arrester 13-1 and varister 14-2, and similarly in a series circuit consisting of the varister 14-1 and gas arrester 13-6. When a lightning surge voltage is applied to the series circuit consisting of the gas arrester 13-1 and varister 14-2, most of the lightning surge voltage is applied to the gas arrester 13-1 due to a capacitance difference between the two. Similarly, in the series circuit consisting of the varister 14-1 and gas arrester 13-6, most of the lightning surge voltage is applied to the gas arrester 13-6.

At this time, the gas arresters 13-1 and 13-6 to which excessive voltages are applied due to the lightning surge, try to start discharging. However, the two rarely start to discharge simultaneously. One of them starts to discharge first due to slight performance difference (i.e., slight difference in discharge voltage) attributable to manufacture lots. It is assumed here that the gas arrester 13-1 starts to discharge first.

When the gas arrester 13-1 starts to discharge, electrical continuity is established between the nodes 15-1 and 15-2, and thus a lightning surge current flows to the varister 14-2. Consequently, the varister 14-2 limits voltage between the nodes 15-2 and 15-7 to a varister voltage because of its own characteristics. As a result, the voltage between the nodes 15-1 and 15-7 becomes equal to the sum (x volts) of an arc voltage at which discharging of the gas arrester 13-1 stabilizes and the varister voltage. Incidentally, x V is larger than the value of the discharge voltage of the gas arrester.

At this time, a voltage of x V is produced in the series circuit consisting of the varister 14-1 and gas arrester 13-6 as well as between the nodes 15-1 and 15-7, but due to a capacitance difference between the varister 14-1 and gas arrester 13-6, most (x1 V) of the x-volt voltage is applied to the gas arrester 13-6. The voltage of x1 V is larger than the value of the discharge voltage of the gas arrester 13-6, and thus the gas arrester 13-6 starts to discharge, electrical continuity is established between the nodes 15-6 and 15-7, and a lightning surge current flows to the varister 14-1. Consequently, the varister 14-1 limits voltage between the nodes 15-1 and 15-6 to a varister voltage because of its own characteristics.

Subsequently, the gas arresters 13-2 to 13-5 discharge in a similar manner in sequence until finally all the gas arresters 13-1 to 13-6 have been discharged and the lightning surge current is released via the gas arresters 13-1 to 13-6. While the gas arresters 13-1 to 13-6 are discharging, the voltage between the nodes 15-1 and 15-7 is equal to the sum (y volts) of the arc voltages of the gas arresters 13-1 to 13-6. Although the arc voltage varies among the individual gas arresters according to arrester specifications, it is on the order of ten-odd volts to tens of volts, and so y V is not an excessive value. Thus, the target apparatus is free from excessive voltage, and it is possible to prevent damage to target apparatus.

Next, description will be given of operations which take place between the low-voltage distribution lines (L1 and L2) and ground when excessive voltages (impulses) such as lightning surges are produced on the low-voltage distribution lines L1 and L2 in the surge protection apparatus in FIG. 1. The description will be provided by citing Cases (1) to (4) below.

(1) Case 1

FIG. 3 is a circuit diagram showing the fuse 4-2 and SPD 10-2 in FIG. 1. FIG. 4 is a voltage waveform diagram according to Case 1 in which an impulse is produced in the low-voltage distribution line L2 in FIG. 3. In FIG. 4, reference numeral 21 denotes an impulse, 22 denotes start of arrester discharge, and 23 denotes arrester arc discharge. FIG. 5 is a diagram showing contributing voltages and the like during arc discharge of the SPD 10-2 in FIG. 1. Incidentally, it is assumed in FIG. 5 that the arc voltage of each arrester during the arc discharge is 15 V, but the arc voltage varies with the gas arrester specifications and may be set to various values.

In the low-voltage distribution line L2 in FIG. 3, when a 200 VAC power supply voltage is on a positive half cycle, if a positive impulse 21 such as shown in FIG. 4 is produced, the gas arresters 13-1 to 13-6 in the SPD 10-2 start to discharge, being triggered by the impulse 21. Consequently, voltage between the low-voltage distribution line L2 and neutral line N reaches an arc discharge voltage. The arc discharge voltage is, for example, 90 V as shown in FIG. 5. On the other hand, the power supply voltage is between +0 V and +300 V (200 VAC rms). As the impulse 21 weakens (falls), the gas arresters 13-1 to 13-6 can no longer sustain the arc discharge.

Conditions which make it impossible to sustain an arc discharge include, for example, the following three conditions: (a) Condition 1 to (c) Condition 3.

(a) Condition 1

FIG. 6 is a diagram showing an example of conditions for an arc discharge with respect to an SPD 13 consisting, for example, of a series circuit of four gas arresters 13-1 to 13-4. FIG. 7 is a diagram showing a situation in which the arc discharge in FIG. 6 does not continue (discontinues).

Suppose, for example, a power supply voltage of +48 VDC (volts direct current) is applied across the SPD 13 as shown in FIG. 6. As shown in FIG. 7, if the arc voltage of the SPD 13, for example, is +60 V, which is higher than the power supply voltage of +48 VDC, the arc discharge of the SPD 13 in FIG. 6 does not continue (never continues in this case).

(b) Condition 2

FIGS. 8(i) and 8(ii) are diagrams showing a situation in which an arc discharge, for example, with respect to the SPD 13 in FIG. 6 does not continue (discontinues).

As shown in FIG. 8(i), if the arc voltage of the SPD 13 is +60 V and the power supply voltage is +100 VAC, i.e., if the arc voltage is lower than the power supply voltage but does not differ much, the arc discharge of the SPD 13 does not continue in many cases. Also, as shown in FIG. 8(ii), if the arc voltage of the SPD 13 is +30 V and the power supply voltage is +48 VDC, i.e., if the arc voltage is lower than the power supply voltage but does not differ much, the arc discharge of the SPD 13 does not continue in many cases. Incidentally, a phenomenon in which the gas arresters 13-1 to 13-4 of the SPD 13 continue arc discharges due to a power supply voltage which is being fed is known as “follow current.”

(c) Condition 3

FIG. 9 is a diagram showing a situation in which an arc discharge, for example, with respect to the SPD 13 in FIG. 6 stops.

If the arc voltage of the SPD 13 is +60 V and is lower than the power supply voltage, which is +100 VAC, the follow current generally stops when the current of the power supply voltage waveform reaches a zero current point 24. It stops at a half wave point of the power supply voltage at the longest.

Thus, in (1) Case 1, although the arc voltage of the SPD 13 is lower than the power supply voltage, since there is only a small difference between the arc voltage and power supply voltage, the arc discharge stops relatively quickly (this corresponds to condition 2 above).

(2) Case 2

FIG. 10 is a diagram showing Case 2 in which an arc discharge, for example, with respect to the SPD 13 in FIG. 6 stops.

In Case 2, the power supply voltage is 100 VAC and the arc voltage is 60 V, for example, and the power supply voltage is on a negative half cycle and there is a negative impulse. In this case (Case 2), polarity is opposite to that in Case 1. As in Case 1, there is a small difference between the arc voltage of −30 V and the power supply voltage of −100 VAC during arc discharge, and thus the arc discharge stops relatively quickly (this corresponds to condition 2 above).

(3) Case 3

FIG. 11 is a diagram showing Case 3 in which an arc discharge, for example, with respect to the SPD 13 in FIG. 6 stops.

In Case 3, the power supply voltage is 100 VAC and the arc voltage is 60 V, for example, and the power supply voltage is on a positive half cycle and there is a negative impulse. In this case (Case 3), there is a large difference between the arc voltage and the power supply voltage during arc discharge, and thus the arc discharge does not stop quickly. It stops when the current of the 100 VAC power supply voltage reaches the zero current point 24 (this corresponds to condition 3 above).

(4) Case 4

FIG. 12 is a diagram showing Case 4 in which an arc discharge, for example, with respect to the SPD 13 in FIG. 6 stops.

In Case 4, the power supply voltage is 100 VAC and the arc voltage is 60 V, for example, and the power supply voltage is on a negative half cycle and there is a positive impulse. In this case (Case 4), polarity is opposite to that in Case 3. As in Case 3, there is a large difference between the arc voltage and the power supply voltage during arc discharge, and thus the arc discharge does not stop quickly. It stops at time 24 when the current of the 100 VAC power supply voltage reaches 0 (this corresponds to condition 3 above).

Now, description will be given of relationship between the fuses (4-1 and 4-2) and SPDs (10-1 and 10-2) in the surge protection apparatus shown in FIG. 1.

If the SPDs 10-1 and 10-2 are short-circuited or otherwise damaged, the fuses 4-1 and 4-2 blow to cut off the low-voltage distribution lines L1 and L2 from the ground. The fuses 4-1 and 4-2 are also blown when an excessive current equal to or larger than a predetermined value flows through them.

Conventionally, fuses 4-1 and 4-2 have ordinary specifications and they do not have very high trip performance. They are rated, for example, at around 200 amperes (A). They have a high capacity in this respect, and thus have a large outer shape.

Since the fuses 4-1 and 4-2 used conventionally are of such a type, even if the SPDs 10-1 and 10-2 come into operation in any of Cases 1 to 4 above, the fuses 4-1 and 4-2 will not blow. Thus, in Cases 3 and 4 above, a commercial supply current flows through the fuses 4-1 and 4-2 (for a half cycle at the most) until the zero current point 24 is reached, but the fuses 4-1 and 4-2 will not blow because the rated current is not exceeded.

Recently, however, specifications of fuses 4-1 and 4-2 have been reviewed, for example, as described in (A) and (B) below.

(A) Fuse Specifications 1

The rated current may be small. For example, a rated current of 200 A is superfluous.

(B) Fuse Specifications 2

With decreases in the rated current, the outer shape of the fuse can be reduced accordingly. For example, conventional fuses measure 100 mm (millimeters)×100 mm×200 mm in outside dimensions and weigh a few kilograms (Kg), but preferably they are more compact in outside dimensions.

Such changes to specifications 1 and 2 have downsized the fuses, but reduced the rated current. That is, the fuses have been made to trip at a smaller current. From another angle, this can be viewed as performance improvement.

However, conventional surge protection apparatus such as shown in FIG. 1 have a problem in that the conventional SPDs 10-1 and 10-2 are affected by the changed specifications 1 and 2 of the fuses 4-1 and 4-2.

That is, in Cases 3 and 4, since a commercial supply current flows through the SPDs 10-1 and 10-2 and fuses 4-1 and 4-2 for a half cycle at the most, the fuses 4-1 and 4-2 blow by reacting to the current flow. Once the fuses 4-1 and 4-2 are blown, they must be reset manually, which requires an operator to operate by visiting the installation site of the surge protection apparatus. This is both inconvenient and disadvantageous.

To deal with this situation, circuit configuration of the SPDs 10-1 and 10-2 must be improved. However, by simply combining the techniques of Patent Documents 1 to 8 and the like, it is difficult to provide a small, reliable, inexpensive SPD relatively simple in structure and a surge protection apparatus using thereof.

### SUMMARY OF THE INVENTION

A first object of the present invention is to provide a small, reliable, inexpensive SPD relatively simple in structure and capable of dealing with direct strokes.

A second object of the present invention is to provide a surge protection apparatus which can prevent a breaking device installed ahead of or behind the SPD from tripping.

To achieve the first object, according to a first aspect of the present invention, there is provided an SPD for power supplies which protects a target apparatus operating on an AC power supply voltage from an abnormal voltage applied to the target apparatus, comprising: a gas arrester to which the AC power supply voltage is applied; a varister group connected in series with the gas arrester and containing a plurality of varisters with high withstand capacity, where the varisters are connected in parallel to one another and each of the varisters has a varister voltage which is set higher than a peak value of the AC power supply voltage; and a resistor which, being connected between both electrodes of the varister group, discharges charges stored in capacitance of the varister group.

To achieve the second object, according to a second aspect of the present invention, there is provided a surge protection apparatus comprising: a breaking device which protects a target apparatus operating on an AC power supply voltage from an abnormal voltage applied to the target apparatus, by blocking the abnormal voltage; and an SPD for power supplies which, being connected in series with the breaking device, protects the target apparatus from the abnormal voltage, wherein the SPD comprises a gas arrester to which the AC power supply voltage is applied, a varister group connected in series with the gas arrester and containing a plurality of varisters with high withstand capacity, where the varisters are connected in parallel to one another and each of the varisters has a varister voltage which is set higher than a peak value of the AC power supply voltage, and a resistor which, being connected between both electrodes of the varister group, discharges charges stored in capacitance of the varister group.

As described above, in the SPD according to the first aspect of the present invention, the gas arrester is connected in series with the varister group consisting of a plurality of varisters which have high withstand capacity and are connected in parallel to one another and the discharge resistor is connected between both electrodes of the varister group. Besides, since the varister voltages are set higher than the peak value of the AC power supply voltage, the varisters are normally insulated from a power supply circuit by the gas arrester. Even if an abnormal voltage is applied, since an operating voltage of the varisters is set higher than the peak value of the AC power supply voltage, AC power supply current will not flow.

Also, current withstand capacity of a varister depends, for example, on its area, and thus the varister group with high withstand capacity has high capacitance. During operation of the gas arrester, the capacitance is charged and maintains voltage. Consequently, when the polarity of the AC power supply voltage is reversed, the voltage maintained by the varisters is added to the AC power supply voltage applied to the gas arrester, which may result in a restrike. According to the first aspect of the present invention, since the resistor is connected between the electrodes of the varister group, charges stored in the varisters are released quickly through the resistor. This makes it possible to prevent the gas arrester from restriking.

The surge protection apparatus according to the second aspect of the present invention can protect the target apparatus reliably from direct strokes and prevent the breaking device installed ahead of or behind the SPD from tripping because the breaking device is connected in series with the SPD according to the first aspect. This makes it possible to omit troublesome operations such as replacement or resetting of the breaking device.

These and other objects and novel features of the present invention will become fully apparent from the following description of the preferred embodiment taken in conjunction with the accompanying drawings. However, the drawings are provided by way of illustration only, and are not intended to limit the scope of the present invention.

### BRIEF DESCRIPTION OF THE DRAWINGS

FIG. 1 is a schematic block diagram showing a conventional surge protection apparatus used to protect a target apparatus connected to a power distribution system (e.g., low-voltage distribution lines in a building or the like) from lightning surges;

FIG. 2 is a schematic circuit diagram showing a configuration of a conventional SPD 10 (SPD 10-1 or 10-2) in FIG. 1;

FIG. 3 is a circuit diagram showing the fuse 4-2 and SPD 10-2 in FIG. 1;

FIG. 4 is a voltage waveform diagram according to Case 1 in which an impulse is produced in a low-voltage distribution line L2 in FIG. 3;

FIG. 5 is a diagram showing contributing voltages and the like during arc discharging of the SPD 10-2 in FIG. 1;

FIG. 6 is a diagram showing an example of conditions for an arc discharge with respect to an SPD 13 consisting of a series circuit of four gas arresters 13-1 to 13-4;

FIG. 7 is a diagram showing a situation in which the arc discharge in FIG. 6 does not continue (discontinues);

FIG. 8 is a diagram showing a situation in which an arc discharge with respect to the SPD 13 in FIG. 6 does not continue (discontinues);

FIG. 9 is a diagram showing a situation in which an arc discharge with respect to the SPD 13 in FIG. 6 stops;

FIG. 10 is a diagram showing Case 2 in which an arc discharge with respect to the SPD 13 in FIG. 6 stops;

FIG. 11 is a diagram showing Case 3 in which an arc discharge with respect to the SPD 13 in FIG. 6 stops;

FIG. 12 is a diagram showing Case 4 in which an arc discharge with respect to the SPD 13 in FIG. 6 stops;

FIG. 13 is a schematic block diagram showing a surge protection apparatus according to a preferred embodiment of the present invention, where the surge protection apparatus is used to protect target apparatus connected to a power distribution system (e.g., low-voltage distribution lines in a building or the like) from lightning surges;

FIG. 14 is a diagram showing an exemplary configuration of a series circuit consisting of one gas arrester 41 and one varister 42-1 in FIG. 13;

FIG. 15 is a diagram showing an exemplary configuration of the varister 42-1 in FIG. 14;

FIG. 16 is a diagram showing an improvement example of the configuration in FIG. 14;

FIG. 17 is a circuit diagram corresponding to each SPD 40 (40-1 or 40-2) in FIG. 13 and obtained by solving circuit problems in FIG. 16(i);

FIG. 18 is a diagram showing performance required of the Class I Test-compliant SPDs 40 (40-1 and 40-2) in FIG. 13;

FIG. 19 is a diagram showing three levels of current values of direct strokes;

FIG. 20 is an operating waveform diagram obtained by applying an impulse voltage to a prototype built for use as the special gas arrester 41 in FIG. 13;

FIG. 21 is an operating waveform diagram obtained when no resistor 43 is installed on the SPDs 40 (40-1 and 40-2) in FIG. 13;

FIG. 22 is an operating waveform diagram showing an operating duty test in FIG. 21.

FIG. 23 is a diagram showing an operating waveform across varisters 42 (42-1 to 42-5) in each SPD 40 (40-1 or 40-2) in FIG. 13 when a resistor 43 is mounted between both ends of the varisters; and

FIG. 24 is an operating waveform diagram showing an operating duty test in FIG. 23.

### DESCRIPTION OF THE PREFERRED EMBODIMENTS

A preferred embodiment of the present invention will be described below with reference to the accompanying drawings.

### EMBODIMENT

### (Overall Configuration of Surge Protection Apparatus According to Preferred Embodiment)

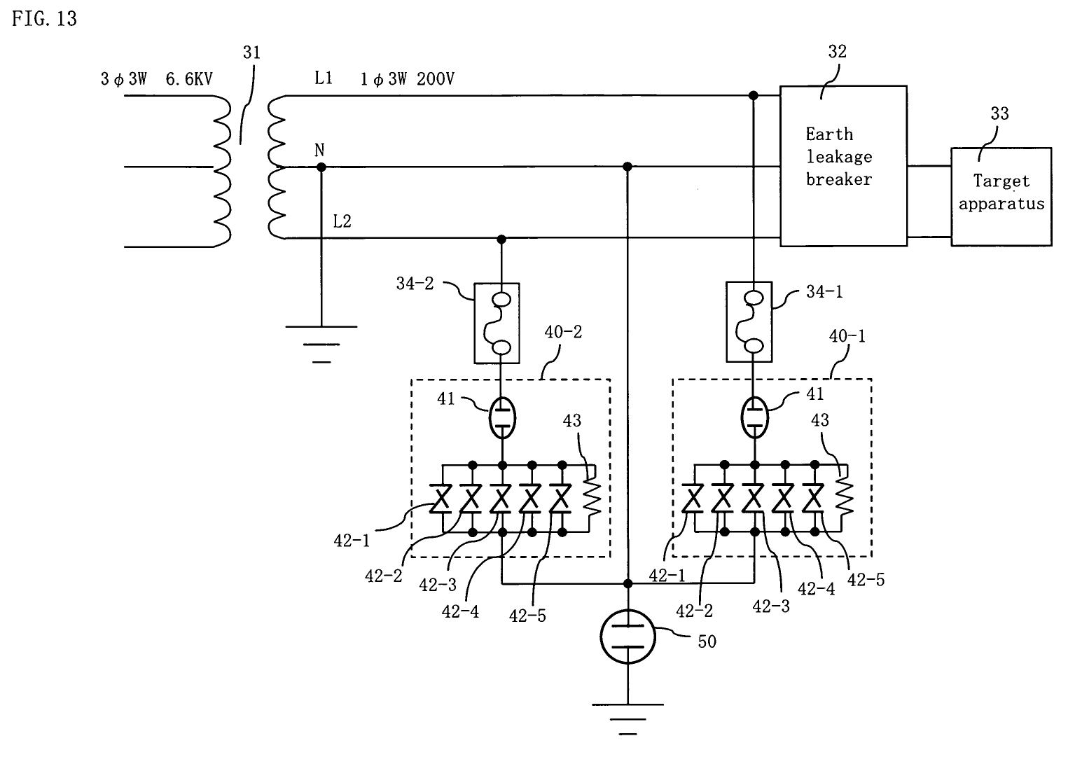

FIG. 13 is a schematic block diagram showing a surge protection apparatus according to a preferred embodiment of the present invention, where the surge protection apparatus is used to protect target apparatus connected to a power distribution system (e.g., low-voltage distribution lines in a building or the like) from lightning surges.

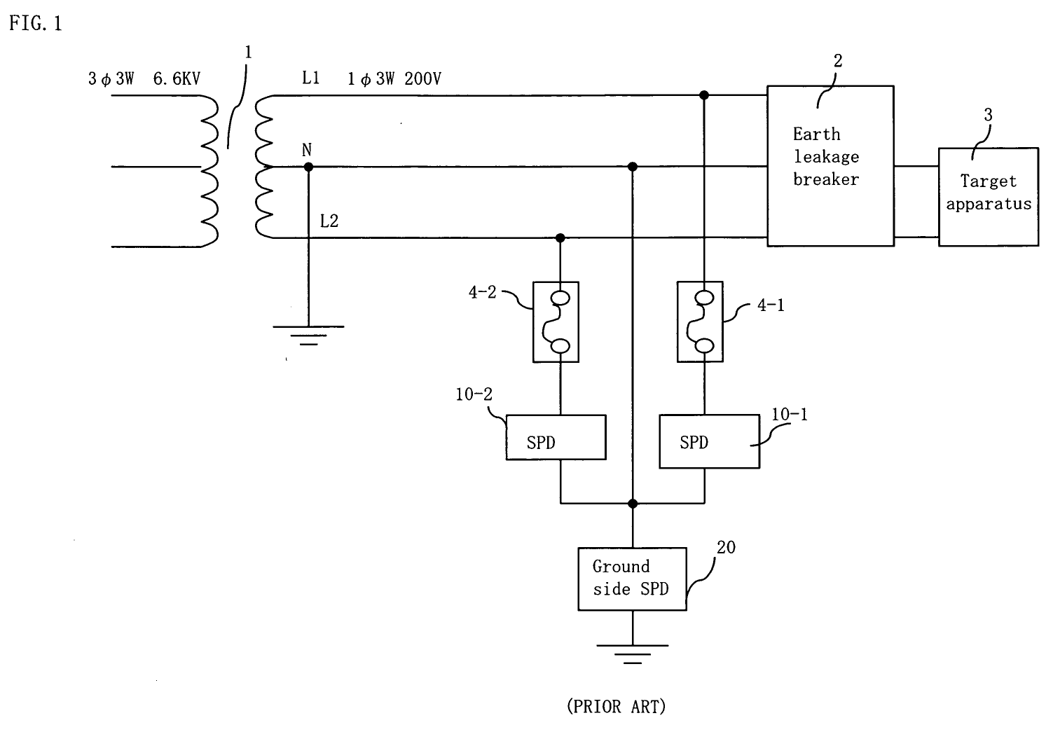

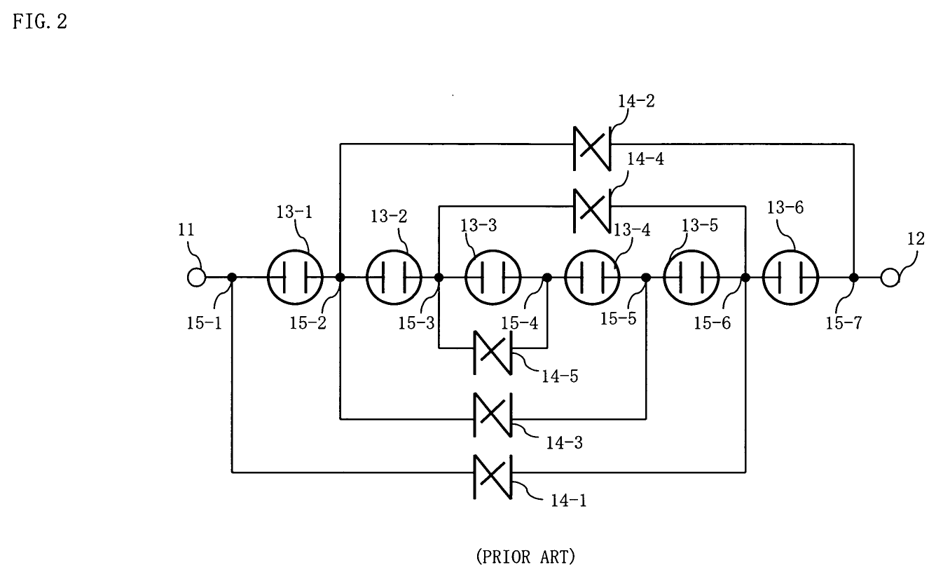

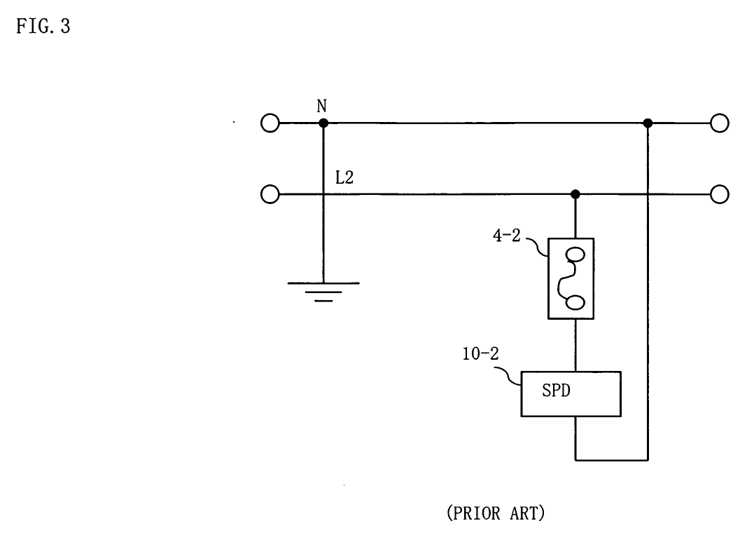

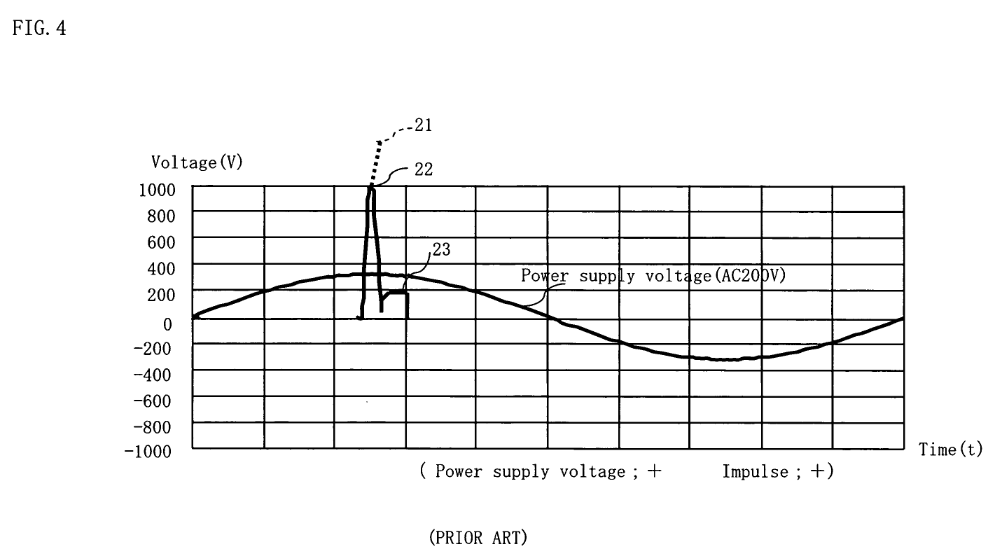

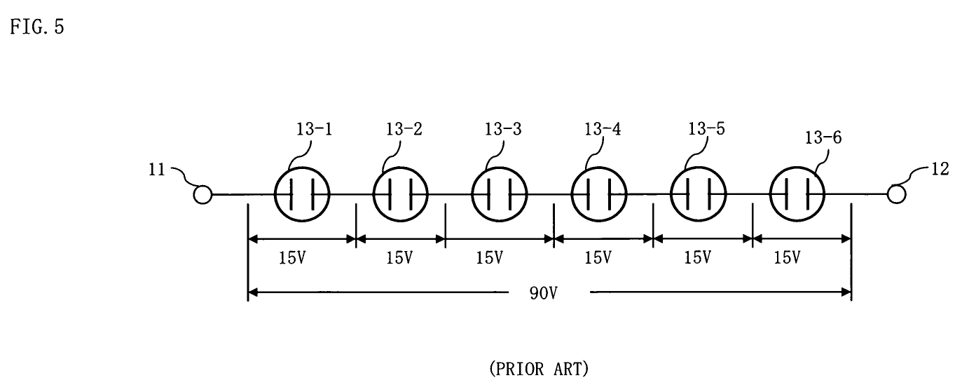

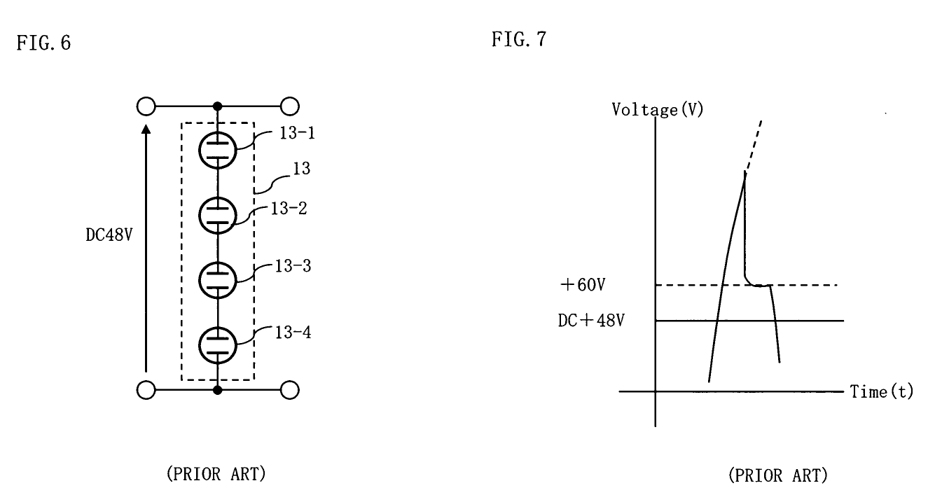

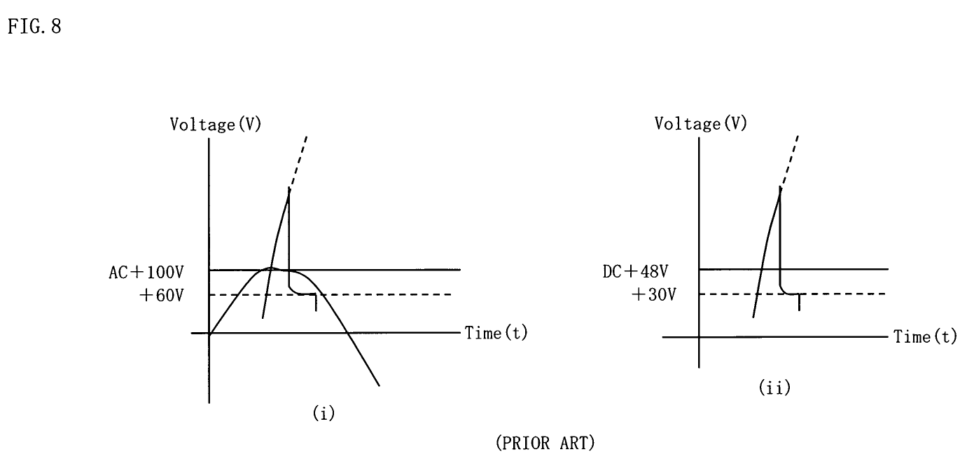

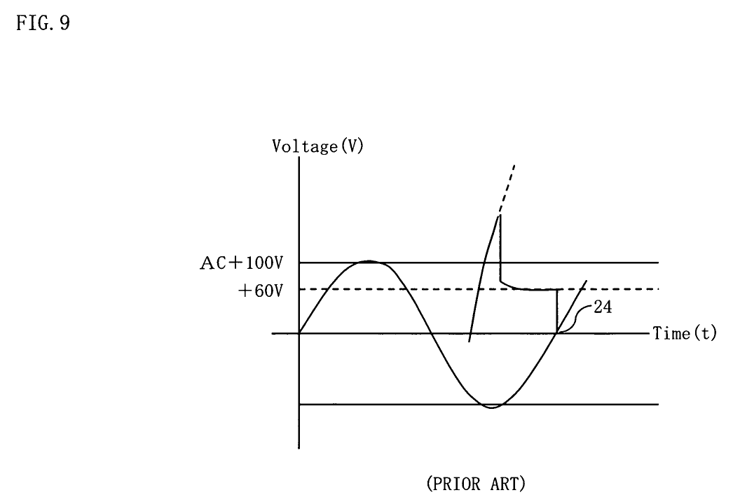

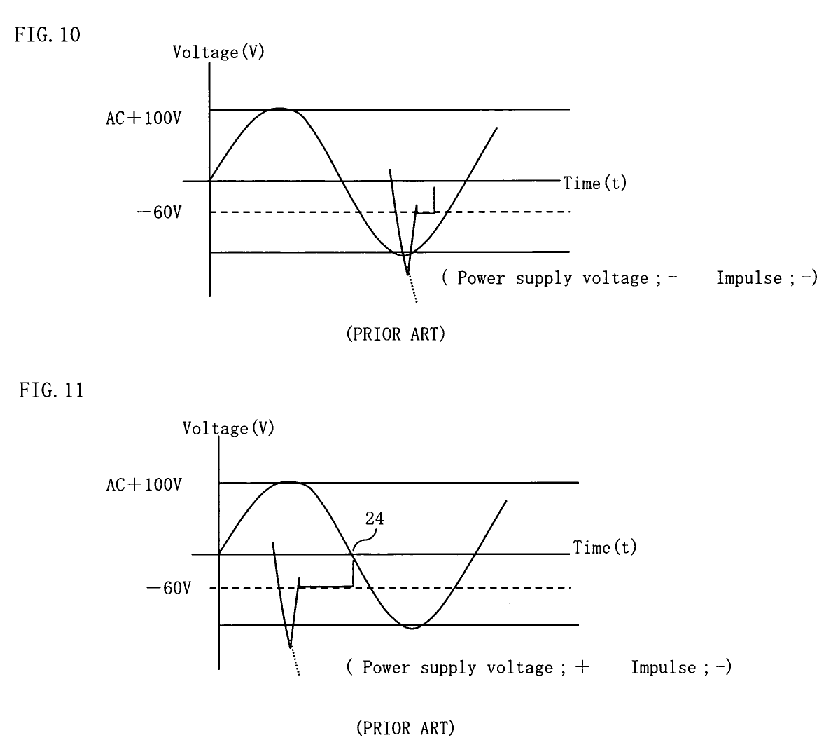

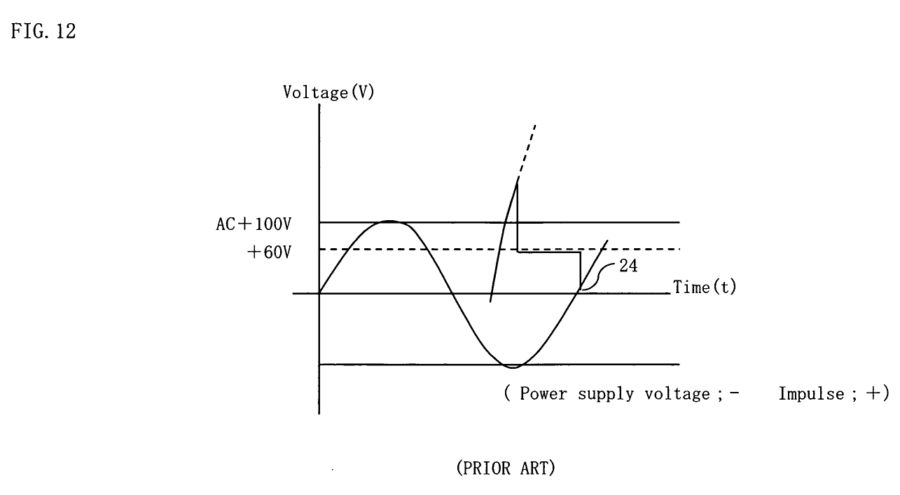

In the circuit in FIG. 13, for example, as in the case of the conventional circuit shown in FIG. 1, if a 6.6-kilovolt high voltage AC of a three-phase (3φ), three-wire system (3 W) is inputted in a high voltage isolation transformer 31, it is supplied to two low-voltage distribution lines L1 and L2 and one neutral line N after being transformed into a low voltage (200 volts AC) of a single phase (1φ), three-wire (3 W) commercial power system by the isolation transformer 31. The 200-volt low voltage AC supplied to the two low-voltage distribution lines L1 and L2 and one neutral line N is supplied to a target apparatus 33 such as an electrical apparatus via an earth leakage breaker 32 to drive the target apparatus 33. The low-voltage neutral line N is grounded. Since lightning surges can occur not only with respect to the ground, but also between lines, in order to protect the target apparatus 33 from lightning surges, it is necessary to provide both apparatus-to-ground protection and line-to-line protection.

Thus, one L1 of the low-voltage distribution lines is connected to the neutral line N via an overcurrent circuit breaking device (e.g., fuse) 34-1 according to the specifications 1 and 2 different from the conventional one and an SPD 40-1 which has a circuit configuration different from the conventional one shown in FIG. 1. Also, the other low-voltage distribution line L2 is connected to the neutral line N via an overcurrent circuit breaking device (e.g., fuse) 34-2 according to the specifications 1 and 2 different from the conventional one and an SPD 40-2 which has a circuit configuration different from the conventional one shown in FIG. 1. Furthermore, the neutral line N is grounded via a ground side SPD (e.g., gas arrester) 50.

Each SPD 40 (i.e., 40-1 or 40-2) consists of one gas arrester 41, multiple (e.g., five) varisters 42-1 to 42-5 connected in parallel to one another and in series with the gas arrester 41, and a discharge resistor 43 connected in parallel to the varisters 42-1 to 42-5. (Configuration of each SPD 40 (i.e., 40-1 or 40-2))

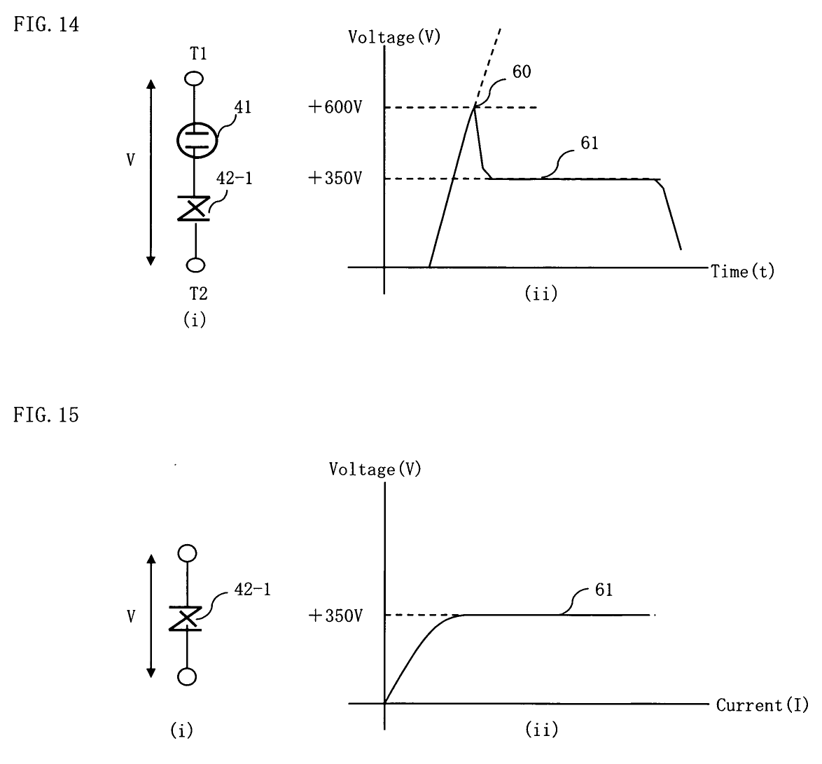

FIGS. 14(i) and 14(ii) are diagrams showing an exemplary configuration of a series circuit consisting of one gas arrester 41 and one varister 42-1 in FIG. 13, where FIG. 14(i) is a circuit diagram of the series circuit and FIG. 14(ii) is a characteristic curve showing a relationship between voltage V and time t in the series circuit.

To solve the conventional problem, it is conceivable to change the circuit configuration of the SPDs 4(4-1 and 4-2), for example, to the one shown in FIG. 14(i).

The SPD in FIG. 14(i) has a circuit configuration in which the series circuit consisting of one gas arrester 41 and one varister 42-1 is connected to two terminals T1 and T2.

In a circuit with this configuration, when, for example, a commercial 200 VAC power supply voltage is applied, an arc discharge will stop quickly as in Cases 1 and 2 above instead of Cases 3 and 4 above in which a commercial supply current flows for a certain period of time.

FIGS. 15(i) and 15(ii) are diagrams showing an exemplary configuration of the varister 42-1 in FIG. 14, where FIG. 15(i) is a circuit diagram of the varister 42-1 and FIG. 15(ii) is a current (I) vs. voltage (V) curve of the varister 42-1.

Operation of the circuit in FIG. 14(i) will be described below with reference to FIGS. 14(ii), 15(i), and 15(ii).

When a high voltage V applied between the terminals T1 and T2 exceeds a +600-volt discharge voltage (60) of the gas arrester, the gas arrester 41 discharges and becomes conductive, causing an impulse current to flow through the varister 42-1. As shown in FIG. 14(ii), the impulse current I flowing through the varister 42-1 increases with time t, but the voltage V across the varister 42-1 is limited to a varister clamping voltage 61 which is almost constant (e.g., 350 V).

In this way, in the circuit in FIG. 14(i), the voltage V between the terminals T1 and T2 is a little over +350 V, which is higher than the commercial 200 VAC power supply voltage. Consequently, the gas arrester 41 does not cause a follow current, and an arc discharge stops quickly. Therefore, no such overcurrent that would cause a fuse 34 (specifically 34-1 or 34-2) connected to the terminal T1 to respond flows through the fuse 34 in FIG. 13. Thus, the fuse 34 does not blow, and it seems that the conventional problem has been solved.

However, the use of the varister 42-1 makes it impossible to satisfy other requirements. That is, the SPDs 40 (40-1 and 40-2) for protection against direct strokes in FIG. 13 pass an impulse current, which is a large current, and thus high withstand capacity (e.g., 25 KA) is required of them. With the SPDs 10 (10-1 and 10-2) of the conventional configuration in FIG. 1, a large current is carried by the gas arresters alone when discharging is stabilized, but there is no problem because gas arresters structurally have high withstand capacity. However, varisters have lower withstand capacity than gas arresters. Thus, it is conceivable to install multiple varisters 42-1 in parallel.

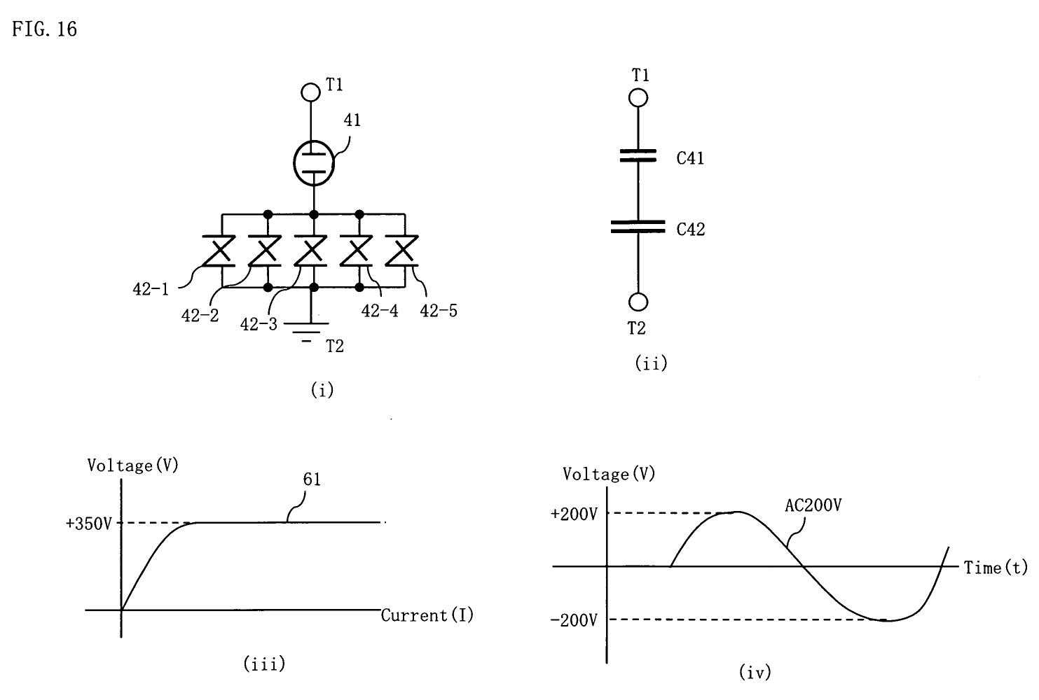

FIGS. 16(i) to 16(iv) are diagrams showing an improvement example of the configuration in FIG. 14.

FIG. 16(i) is a circuit diagram showing an exemplary configuration in which multiple (e.g., five) varisters 42-1 to 42-5 are connected in parallel to one another in the circuit of FIG. 14(i).

When multiple varisters 42-1 to 42-5 are connected in parallel to one another as in the case of the circuit in FIG. 16(i), since a large current flowing through the gas arrester 41 is divided among the multiple varisters 42-1 to 42-5, the withstand capacity of the entire SPD in FIG. 16(i) improves according to the number of varisters 42-1 to 42-5. However, the circuit configuration in FIG. 16(i) poses a new problem.

FIG. 16(ii) is a diagram showing a capacitance equivalent circuit of the circuit in FIG. 16(i).

The equivalent circuit in FIG. 16(ii) consists of capacitance C41 of the gas arrester 41 and total capacitance C42 of the multiple varisters 42-1 to 42-5 connected in parallel to one another, where the capacitance C41 and capacitance C42 are connected in series with each other. The multiple varisters 42-1 to 42-5, each of which has a large capacitance, produce a very large total capacitance C42 when connected in parallel. Consequently, after a large current flows through the circuits in FIGS. 16(i) and 16(ii), large amounts of charges are accumulated in the multiple varisters 42-1 to 42-5.

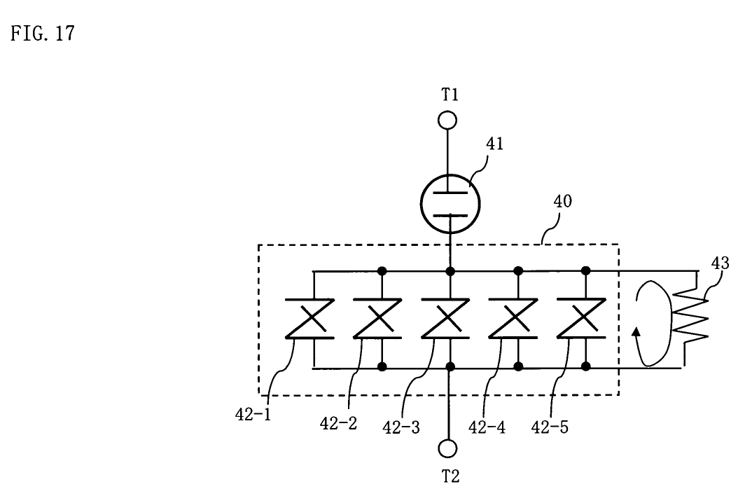

FIG. 16(iii) is a current I vs. voltage V curve which represents the varister clamping voltage 61 in the varisters 42-1 to 42-5. FIG. 16(iv) is a time t vs. voltage V curve which represents the commercial 200 VAC power supply voltage applied between the terminals T1 and T2 in FIG. 16(i). Furthermore, FIG. 17 is a circuit diagram corresponding to each SPD 40 (40-1 or 40-2) in FIG. 13 and obtained by solving circuit problems in FIG. 16(i).

As shown in FIG. 16(iii), after the gas arrester 41 stops discharging, charged voltage 350 V remains in the varisters 42-1 to 42-5 for a long time, but the gas arrester 41 will not start discharging again (i.e., restriking) on the charged voltage 350 V alone.

However, as shown in FIG. 16(iv), when the polarity of the commercial 200 VAC power supply voltage is reversed over time t, the sum (e.g., 350 V−(−200V)=550 V) of the charged voltage 350 V and the reversed commercial 200 VAC power supply voltage (−200 VAC) is applied to the gas arrester 41. Consequently, the total voltage (e.g., 550 V) can exceed the discharge voltage of the gas arrester 41, in which case, the gas arrester 41 can discharge again. In the worst case, the gas arrester 41 may repeat ignition and extinction in sync with the cycles of the commercial 200 VAC power supply voltage.

In that case, the commercial supply current will also flow during conduction, causing a current to flow through the fuses 34-1 and 34-2 in FIG. 13 for a long period of time, thereby blowing the fuses 34-1 and 34-2. Then, it is not possible to solve the conventional problem. Thus, as shown in FIG. 17, the discharge resistor 43 is connected in parallel to the varisters 42-1 to 42-5.

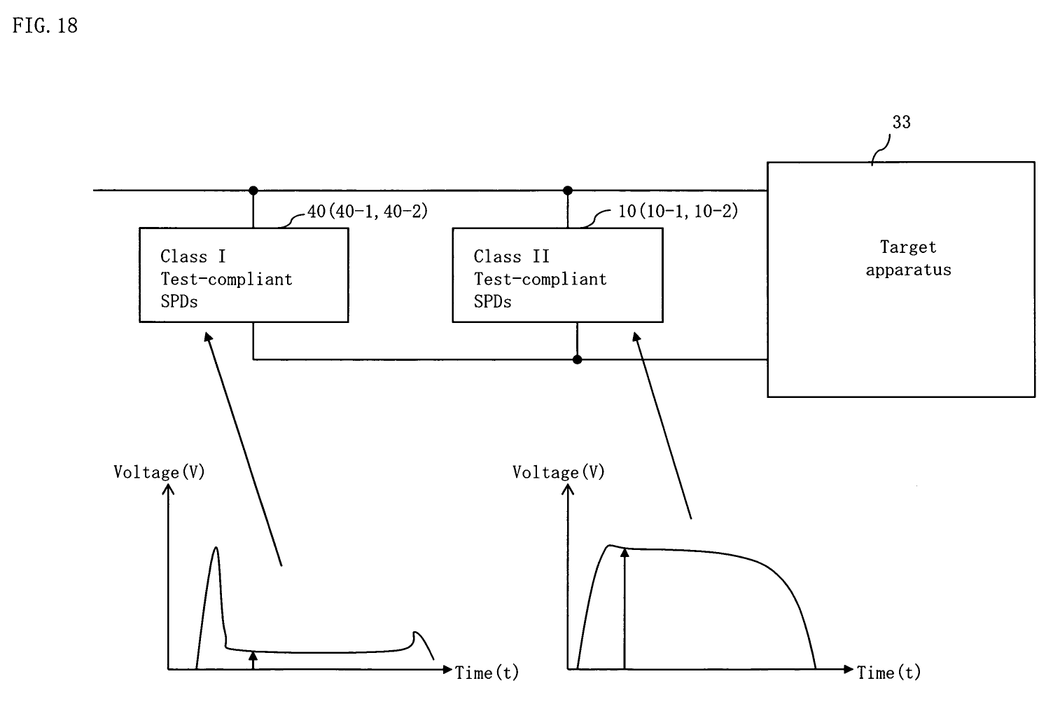

In the circuit shown in FIG. 17, when the gas arrester 41 stops discharging, the terminals T1 and T2 are disconnected from each other while the varisters 42-1 to 42-5 are charged with a 350-volt voltage. However, the charging voltage is discharged quickly via the resistor 43, and the gas arrester 41 will not restrike. (Concrete design example of SPDs 40 (40-1 and 40-2)) FIG. 18 is a diagram showing performance required of the Class I Test-compliant SPDs 40 (40-1 and 40-2) in FIG. 13.

To protect the target apparatus 33 in FIG. 18 from lightning surges, the Class I SPDs 40 (40-1 and 40-2) in FIG. 13 which provide for shunt currents from direct strokes are now required by JIS (Japanese Industrial Standards) C 5381-1 and related JIS encodings instead of the conventional Class II SPDs 10 (10-1 and 10-2) in FIG. 1 intended for protection from indirect strokes, where JIS C 5381-1 has been newly prepared to conform, for example, to international standard IEC (International Electrotechnical Commission) . For example, JIS (Japanese Industrial Standards) C 0367 evaluates the current of direct strokes on a three-level scale.

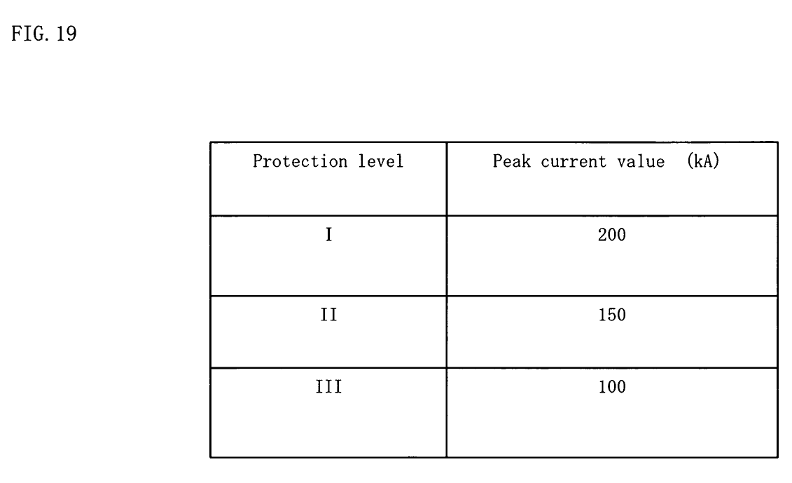

FIG. 19 is a diagram showing three levels of current values of direct strokes.

As shown in FIG. 19, three protection levels are provided according to importance of target objects such as buildings and a magnitude of lightning current is specified for each protection level. For example, the highest protection level I indicates that lightning protection should be designed so that the target object will be protected from an extremely large lightning current with a peak current value of 200 kA.

When it is difficult to calculate shunt currents of a direct stroke, it should be assumed that a lightning current of 50% the original magnitude branches to a power distribution system. The number of cables in a distribution line is based on the assumption of a single phase, two-wire system, and the lightning current flowing to one wire is 50 kA at the maximum. JIS C 0367 assumes that a direct stroke has a 10/350 μs (microsecond) current waveform. The SPDs 10 (10-1 and 10-2) which are conventionally intended for indirect strokes have been rated based generally on an 8/20 μs current waveform.

On the other hands, performance requirements for the Class I Test-compliant SPDs 40 (40-1 and 40-2), for example, include the following two.

Class I Test-compliant SPDs shall have enough performance to withstand shunt currents of lightning current at each protection level assumed by JIS A 4201 “Lightning Protection of Buildings and the Like.” A calculated maximum value is 50 kA for 10/350 μs per phase in the case of a single phase, two-wire system.

Class I Test-compliant SPDs shall be able to operate in cooperation with the Class II Test-compliant SPDs 10 (10-1 and 10-2). Most part of lightning current must be processed by the Class I Test-compliant SPDs 40 (40-1 and 40-2). For that, as shown in FIG. 18, operating voltages must satisfy the relationship: the Class I Test-compliant SPDs 40 (40-1 and 40-2)<Class II Test-compliant SPDs 10 (10-1 and 10-2).

When considering the two functions described above, currently the possibility that a direct stroke with a peak current above 200 kA will occur is less than 10%. Besides, in view of the fact that most power distribution systems in Japan use three-phase or single phase, three-wire systems, it can be said that it is sufficient to allow for a shunt current of around 25 kA ( 10/350 μs).

Thus, according to the first embodiment, the Class I Test-compliant SPD 40 (40-1 and 40-2) has been developed as follows

As shown in FIG. 18, the Class I Test-compliant SPDs 40 (40-1 and 40-2) not only have very high current withstand capacity as described above, but also need to operate in cooperation with the Class II Test-compliant SPDs 10 (10-1 and 10-2). When installing the Class I Test-compliant SPDs 40 (40-1 and 40-2) on the power supply side and installing the Class II Test-compliant SPDs 10 (10-1 and 10-2) on the same line, but on the side of the target apparatus 33, it is ideal to pass main current through the Class I Test-compliant SPDs 40 (40-1 and 40-2) installed on the power supply side and pass almost no current through the Class II Test-compliant SPDs 10 (10-1 and 10-2) if electromagnetic induction and the like are taken into consideration.

Regarding a basic performance requirement for the SPDs 40 (40-1 and 40-2) for power supplies, the SPDs are required to have a sufficient follow current interrupting rating. If this performance requirement cannot be satisfied by the SPDs alone, it must be satisfied in conjunction with backup breakers (e.g., the fuses 34-1 and 34-2 in FIG. 13) or the like. In particular, the Class I Test-compliant SPDs 40 (40-1 and 40-2), which are installed at a point of power supply, desirably have a large follow current interrupting rating as well because of high short-circuit capacity of the power supply.

Thus, the following development targets were set for the performance of the most versatile Class I Test-compliant SPDs 40 (40-1 and 40-2) and specifications (A) to (D) were laid out.

Current withstand capacity (impulse current): Iimp= 10/350 μs 25 kA

Maximum service voltage: Uc=230V

Voltage protection level: Up=1500 V or below (the lowest possible value)

(Needed for cooperation with Class II Test-compliant SPDs)

Follow current interrupting rating: Ifi=50 kA (Uc=230 50/60 Hz)

(Must be larger than short-circuit current of the power supply)

Leakage current IPE=3 μA or below at 320 VDC

(A) Specifications of devices used for SPDs 40 (40-1 and 40-2) in FIG. 13

For example, if a gap arrester or gas arrester is used alone, switching to a low voltage will occur during operation, which may cause follow current. If a voltage higher than the power supply voltage does not exist between the terminals of an SPD during operation, operational state will be sustained by the power supply voltage. To provide the voltage during operation, an element which produces a voltage higher than the peak value of the power supply voltage is used in combination with a gas arrester from the viewpoint of preventing follow current. For these reasons, the SPD 40 (40-1 or 40-2) according to this embodiment is composed of a series circuit of the special gas arrester 41 and varisters 42.

(B) Specifications of varisters 42 (42-1 to 42-5)

The operating voltage V1 of a varister is generally defined in milliamperes (mA) . The operating voltage of the varisters 42 used for the SPD 40 (40-1 or 40-2) is set, for example, to 320 V or above, considering the maximum service voltage Uc of 230 V (AC) . The current withstand capacity of the varisters 42 can be doubled by connecting varisters of almost the same operating voltage in parallel. In the SPD 40 (40-1 or 40-2), five varisters 42 (42-1 to 42-5) with current withstand capacity of 5500 A ( 10/350 μs) each are used in parallel to satisfy Iimp=25 kA as well as to meet dimensional constraints.

(C) Specifications of special gas arrester 41

The special gas arrester 41 should be designed such that a lower limit of the operating voltage will not fall below, for example, 320 V even if an impulse current is applied multiple times. Generally, the gas arrester used in the SPDs 40 (40-1 and 40-2) for power supplies are made to turn off easily due to self-heating during operation using a few percent of active gas such as hydrogen, but at the same time, the heating facilitates electrode wear, causing fluctuations in the operating voltage. To prevent this, inert gas is used instead of hydrogen gas for the special gas arrester 41 in the SPDs 40 (40-1 and 40-2).

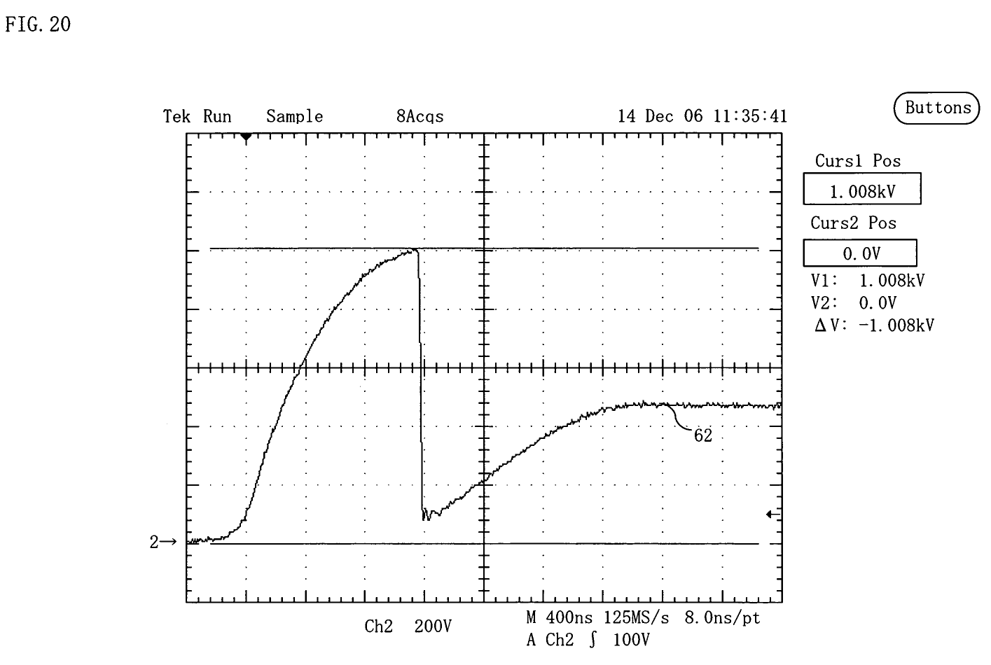

FIG. 20 is an operating waveform diagram obtained by applying an impulse voltage to a prototype built for use as the special gas arrester 41 in FIG. 13.

In FIG. 20, by setting the operating voltage in part 62 of the waveform at a sufficiently large value than the power supply voltage and using the varisters 42 with sufficiently high current withstand capacity, it is possible to obtain properties which do not cause follow current and do not pass current other than impulse current.

(D) Addition of Resistor 43

With varister type lightning arresters, increase in current withstand capacity results in increase in capacitance. The same is true of the varisters 42 (42-1 to 42-5) used in the SPDs 40 (40-1 and 40-2) without exception. The increase is on the order of, for example, 5600 picofarad (pF) per varister. This figure is too large to ignore. Needless to say, a high capacitance means that a large amount of charge is stored and that voltage is maintained even after extinction of a surge.

Thus, each SPD 40 (40-1 or 40-2) in FIG. 13 is configured to quickly discharge the charges stored in the capacitance of the varisters 42-1 to 42-5 via the resistor 43 installed between both electrodes of the varisters 42-1 to 42-5. A commercially available voltage continues to be applied to the SPD 40 (40-1 or 40-2), which is used for a power supply. The SPD 40 must come into operation upon entry of a lightning surge and turn off quickly after the surge.

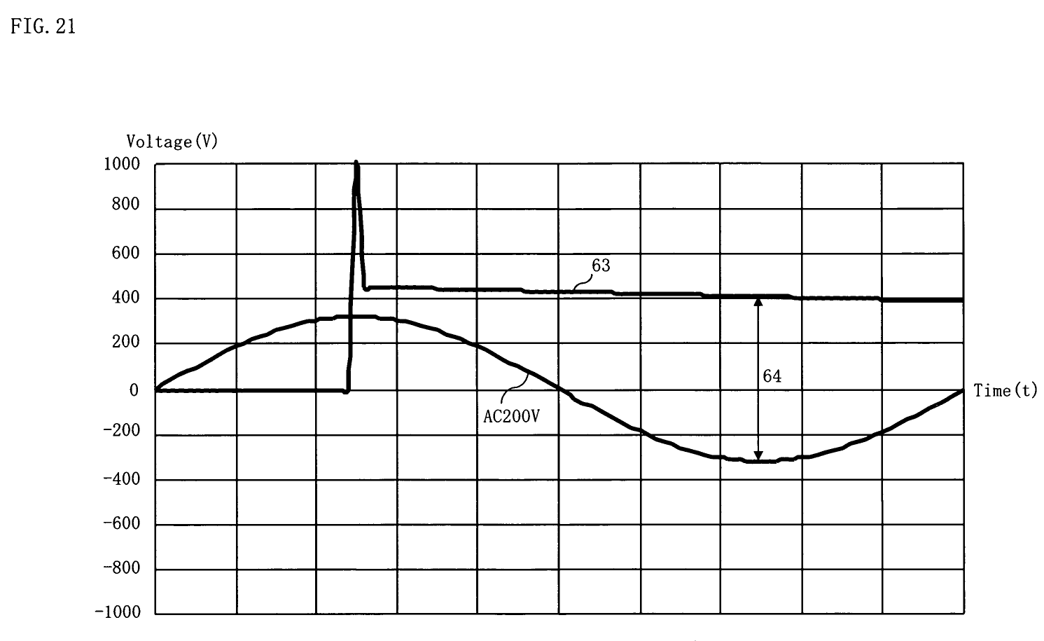

FIG. 21 is an operating waveform diagram obtained when no resistor 43 is installed on the SPDs 40 (40-1 and 40-2) in FIG. 13.

FIG. 21 shows a waveform of the commercial 200 VAC power supply voltage and a waveform of a voltage (i.e., voltage across the varisters) 63 maintained by the capacitance of the varisters 42 (42-1 to 42-5).

When no resistor 43 is mounted, the commercial 200 VAC power supply voltage and the voltage 63 maintained by the capacitance of the varisters 42-1 to 42-5 are applied to the gas arrester 41. Thus, when a voltage 64 becomes higher than the operating voltage of the gas arrester 41, the gas arrester 41 restrikes and remains on, destroying the SPDs 40 (40-1 and 40-2) themselves in the worst case.

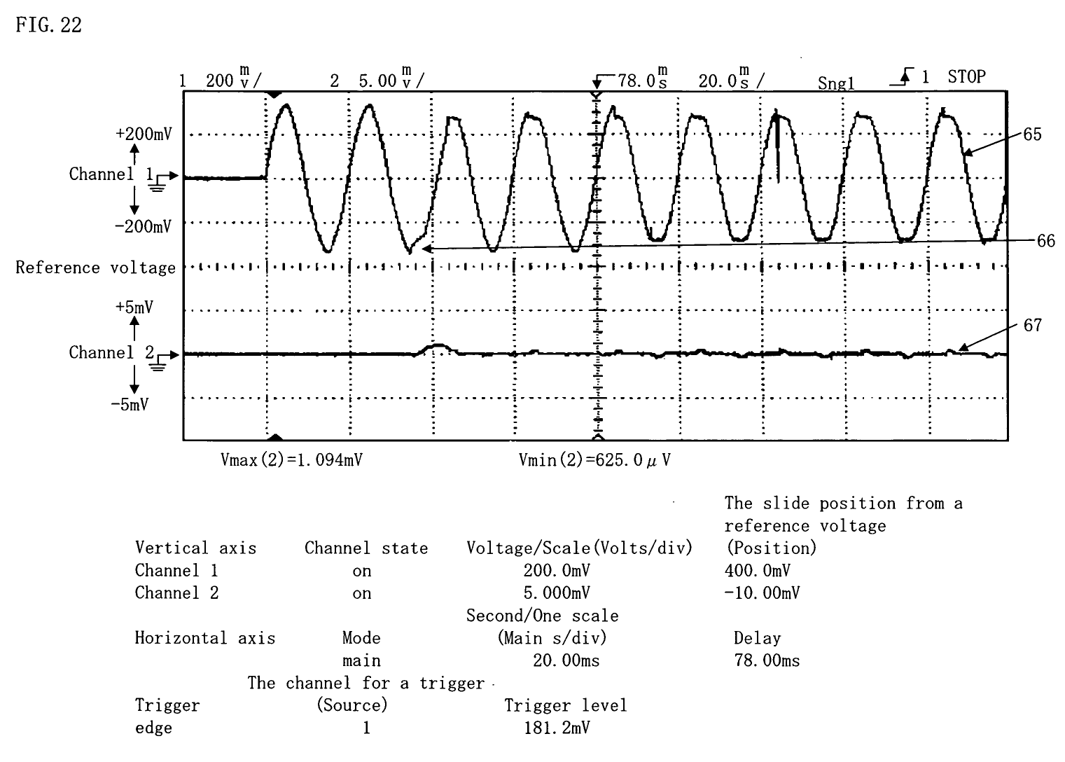

FIG. 22 is an operating waveform diagram showing an operating duty test in FIG. 21.

FIG. 22 shows a voltage waveform 65 across the SPD, a surge application point 66, and a current waveform 67 of a current flowing through the SPD 40 (40-1 or 40-2). The voltage waveform 65 is a waveform of 200 VAC. Incidentally, a 1000:1 probe is used, meaning that one division equals 200 mV. The current waveform 67 is actually obtained by conversion. That is, since a 1000:1 probe is used, the vertical axis is graduated at 5 A/1 intervals in terms of current. Thus, the current waveform 67 is a result of a voltage-current conversion. On the other hand, Delay in FIG. 22 represents a capability to display past data, in terms of milliseconds.

With no resistor 43 mounted, when a surge is applied, after the SPDs 40 (40-1 and 40-2) operate, the voltage 63 maintained by the capacitance of the varisters 42 (42-1 to 42-5) causes the gas arrester 41 to continue restriking. This is because the operating voltage of the varisters 42 (42-1 to 42-5) is low, charges continue to be stored in the capacitance of the varisters 42 (42-1 to 42-5), and the operating voltage of the gas arrester 41 falls.

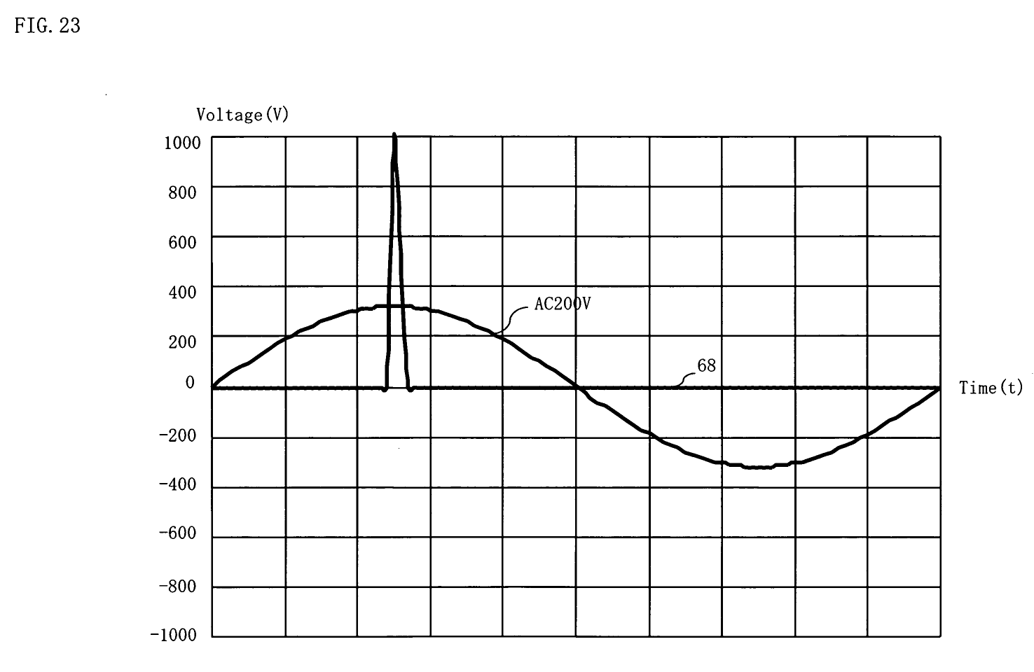

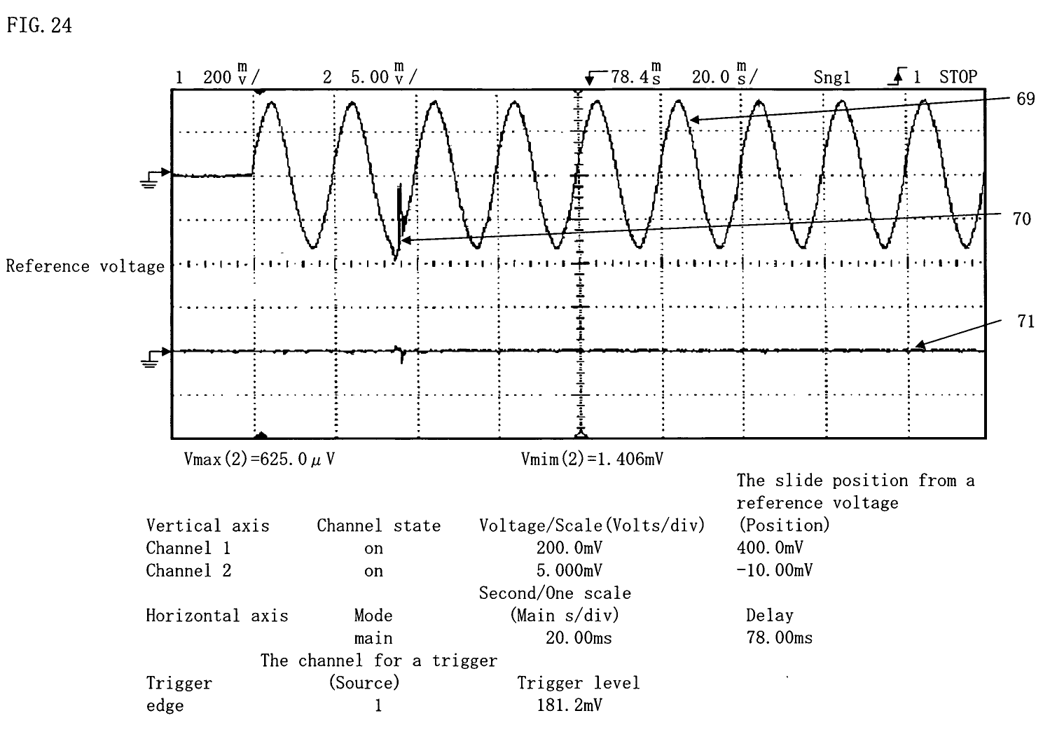

FIG. 23 is a diagram showing an operating waveform across the varisters 42 (42-1 to 42-5) in each SPD 40 (40-1 or 40-2) in FIG. 13 when a resistor 43 is mounted between both ends of the varisters.

FIG. 23 shows a waveform of the commercial 200 VAC power supply voltage and a waveform of the voltage 68 across the varisters.

When the resistor 43 is mounted at both ends of the varisters 42 (42-1 to 42-5), the charges stored in the capacitance of the varisters 42 (42-1 to 42-5) are discharged quickly after extinction of the surge. Consequently, the gas arrester 41 will not restrike unless its operating voltage falls below the commercial 200 VAC power supply voltage. With this configuration, the SPDs 40 (40-1 and 40-2) pass only surges without unnecessarily affecting the commercial power supply voltage.

FIG. 24 is an operating waveform diagram showing an operating duty test in FIG. 23.

FIG. 24 shows a voltage waveform 69 across the SPD, a surge application point 70, and a current waveform 71 of a current flowing through the SPD 40 (40-1 or 40-2). The voltage waveform 69 is a waveform of 200 VAC as in the case of FIG. 22. Incidentally, a 1000:1 probe is used, meaning that one division equals 200 mV. The current waveform 71 is actually obtained by conversion. That is, since a 1000:1 probe is used, the vertical axis is graduated at 5 A/1 intervals in terms of current. Thus, the current waveform 71 is a result of a voltage-current conversion. On the other hand, Delay in FIG. 24 represents a capability to display past data, in terms of milliseconds.

By using the special gas arrester 41, setting the operating voltage of the varisters 42 (42-1 to 42-5) higher than the commercial 200 VAC power supply voltage and lower than 400 V, connecting five varisters 42-1 to 42-5 of the same operating voltage in parallel, and connecting an appropriate resistor 43 at both ends of the varisters 42-1 to 42-5, it is possible to provide Class I Test-compliant SPDs 40 (40-1 and 40-2) which can operate in cooperation with Class II Test-compliant SPDs 10 (10-1 and 10-2) without affecting the power supply system.

### Advantages of Embodiment

According to this embodiment, the SPDs 40 (40-1 and 40-2) are connected in series with the respective fuses 34-1 and 34-2. Also, they are connected in series with the respective gas arresters 41, respective groups of varisters 42-1 to 42-5 connected in parallel to one another, and respective resistors 43. This makes it possible to protect the target apparatus 33 reliably from direct strokes and prevent the fuses 34-1 and 34-2 installed ahead of or behind the SPDs 40 (40-1 and 40-2) from tripping. This also makes it possible to extend product life, compared to the conventional SPDs 10 (10-1 and 10-2). Besides, the relatively simple circuit configuration makes it possible to provide a small, reliable, inexpensive product. Moreover, as JIS (Japanese Industrial Standards) has adopted measures against direct strokes in line with IEC standards, the SPDs 40 (40-1 and 40-2) make a substitute for the conventional SPDs 10 (10-1 and 10-2).

### (Variations)

The present invention is not limited to the above embodiment, and various applications and variations are possible. Such applications and variations include, for example, (a) to (d) below.

(a) The overall configuration of the surge protection apparatus in FIG. 13 may be changed to another circuit configuration.

(b) The configuration of the SPDs 40 (40-1 and 40-2) in FIG. 13 may be used for a surge protection devices other than that of FIG. 13.

(c) The number of varisters in each SPD 40 (40-1 or 40-2) in FIG. 13 may be other than five (42-1 to 42-5).

(d) Other breaking devices (such as circuit breakers or various breakers) may be used instead of the fuses 34-1 and 34-2 in FIG. 13.

1. A surge protection device for power supplies which protects a target apparatus operating on an alternating current power supply voltage from an abnormal voltage applied to the target apparatus, comprising:
a gas arrester to which the alternating current power supply voltage is applied;
a varister group connected in series with the gas arrester and containing a plurality of varisters with high withstand capacity, where the varisters are connected in parallel to one another and each of the varisters has a varister voltage which is set higher than a peak value of the alternating current power supply voltage; and
a resistor which, being connected between both electrodes of the varister group, discharges charges stored in capacitance of the varister group.

2. The surge protection device according to claim 1, wherein:
the abnormal voltage is due to an indirect stroke and a direct stroke; and
the surge protection device is capable of blocking the direct stroke and operating in cooperation with another surge protection device which blocks the indirect stroke.

3. The surge protection device according to claim 1, wherein the gas arrester uses an inert gas.

4. A surge protection apparatus comprising:
a breaking device which protects a target apparatus operating on an alternating current power supply voltage from an abnormal voltage applied to the target apparatus, by blocking the abnormal voltage; and
a surge protection device for power supplies which, being connected in series with the breaking device, protects the target apparatus from the abnormal voltage,
wherein the surge protection device comprises
a gas arrester to which the alternating current power supply voltage is applied,
a varister group connected in series with the gas arrester and containing a plurality of varisters with high withstand capacity, where the varisters are connected in parallel to one another and each of the varisters has a varister voltage which is set higher than a peak value of the alternating current power supply voltage, and
a resistor which, being connected between both electrodes of the varister group, discharges charges stored in capacitance of the varister group.

5. The surge protection apparatus according to claim 4, wherein:
the abnormal voltage is due to an indirect stroke and a direct stroke; and
the surge protection device is capable of blocking the direct stroke and operating in cooperation with another surge protection device which blocks the indirect stroke.

6. The surge protection apparatus according to claim 4, wherein the gas arrester uses an inert gas.

7. The surge protection apparatus according to claim 4, wherein the breaking device is a fuse or breaker.
